(19) United States
(12) Patent Application Publication
(10) Pub. No.: US 2006/0203505 A1
(43) Pub. Date: Sep. 14, 2006

(54) Wideband illumination device

(76) Inventors: Manfred Griesinger, Leonberg (DE); Markus Hartlieb, Walddorhaeslach (DE); Wolhelm E. Kincses, Stuttgart (DE); Hans-Georg Leis, Esslingen (DE); Sigfried Rothe, Denkendorf (DE)

Correspondence Address: AKERMAN SENTERFITT, P.O. BOX 3188, WEST PALM BEACH, FL, 33402-3188, US

(21) Appl. No.: 10/536,339

(22) PCT Filed: Nov. 11, 2003
(86) PCT No.: PCT/EP03/12576

§ 371 Date: Mar. 13, 2006

(30) Foreign Application Priority Data
Nov. 25, 2002 (DE) 102 55 015.8

(51) Int. Cl. F21S 8/10

(52) U.S. Cl. 362/545

(57) ABSTRACT

The invention relates to a wideband illumination device comprising a plurality of semiconductor light sources arranged in a field as a light source, for obtaining a specified light distribution for a vehicle headlight in different operating conditions. Parts of the semiconductor light sources are able to emit light in the visible wavelength region, while others emit light in the non-visible wavelength region. In an especially advantageous manner, individual optical elements are associated with the semiconductor light sources, either individually or in groups, for the targeted production of different radiation characteristics. One such wideband illumination device can be used to create a compact individual headlight by which means both the immediate vicinity and the main beam region in front of a motor vehicle can be illuminated with visible light. The same headlight can also be used to provide light in the non-visible region for using with systems for improving night vision.

### BACKGROUND OF THE INVENTION

1. Field of the Invention

The invention relates to a wideband illumination device, in particular for use in a motor vehicle and a method suitable for operating such a device according to the preamble of patent claims 1 and 14.

2. Related Art of the Invention

Poor visibility at night is a taxing and hazardous situation that is feared by many drivers. As a consequence of poor visibility, the accident rate at night is significantly higher than for journeys during the day and with good visibility. In particular, the following difficulties occur at night:
The visibility range with low-beam light with oncoming traffic is small and is estimated incorrectly by many drivers. This leads to late recognition of unilluminated obstacles, pedestrians, cyclists without lights and animals, and thus to accidents.
The headlights of oncoming vehicles and the reflections thereof, primarily when the roadway is wet, dazzle the driver; the driver momentarily drives into a black hole. Night-blind and older drivers are particularly at risk owing to their lower visual acuity.
In rain, fog and driving snow, the visibility conditions may again be significantly worse.

In order to be able to illuminate traffic scenes at night as well as possible, there are vehicle headlights whose luminous characteristic can be adapted to the course of the road. These headlights can be tilted by motor in the vertical in order to compensate for different loading states or to illuminate bumps or troughs in front of the vehicle, or can be pivoted in the horizontal in order to illuminate bends. The requisite mechanism is very complicated and prone to faults, and as an alternative there remains only the possibility of providing different types of headlights between which a changeover can be made. Corresponding special headlights can also be used in order, by way of example, to generate a wider and more lowered illumination in fog or falling snow. For design and costs reasons, however, it is often undesirable to equip a vehicle with excessively many headlights.

A further improvement of visibility at night is achieved by means of an optoelectronic system set forth in DE 40 07 646 A1. The system records a video image of a traffic scene and presents it to the driver in a suitable manner. The image presented contains additional information that the driver cannot detect with his own eyes or can detect only with difficulty, in particular when it is dark, in poor weather and in fog.

The system contains, in addition to the normal head-lights, two infrared headlights that utilize laser diodes emitting in the near infrared as a light source. The laser diodes are operated in pulsed fashion. A CCD camera for recording the video image is accommodated in the roof region of the vehicle. The CCD camera has an electronic shutter that is synchronized with the laser diodes. An optical bandpass filter is fitted in front of the camera objective. The video image is shown to the driver on an LCD display. The use of laser light has a series of advantages:

The lasers emit at a wavelength of 810 nm in the near infrared. Since infrared light is virtually invisible to the human eye, permanent, high-beam illumination can be effected.

By using semiconductor light sources, it is possible to considerably reduce the dazzling of the camera by the visible headlights of oncoming vehicles. Firstly, the light from semiconductor light sources only has a spectral range of a few nm, whereas visible light sources such as halogen lamps have a range of several hundred nm. When an optical filter with a narrow passband is introduced in front of the camera objective, then virtually the entire laser light is transmitted, while the light of oncoming vehicles is attenuated by a factor of 50 to 100. Secondly, laser diodes follow the driver current directly; they can be pulsed rapidly in a simple manner. If a video camera with a fast electronic shutter synchronized with the lasers is used, then the light of oncoming vehicles can be reduced further.

The German patent application DE 101 29 743 (vehicle headlight), published after the priority date, shows a two-dimensional array comprising a multiplicity of electronic light sources set up for emitting a multiplicity of light beams parallel to one another, a converging lens arranged at the distance of its focal length essentially parallel to the area of the array in order to receive the light from the array, and drive electronics for the light sources, which are set up to permit the light sources to emit light individually or groupwise-selectively. The patent application furthermore provides for combining light sources that emit light in the visible wavelength region with those light sources which emit light in the non-visible wavelength region. The apparatus demonstrated enables the luminous characteristic of the headlight to be adapted to the variable driving or ambient conditions solely with the aid of the drive electronics. Therefore, there is no need for any mechanically movable parts whatsoever either, all the light sources being assigned, however, a common optical arrangement that determines the emission characteristic of the headlight.

### SUMMARY OF THE INVENTION

It is an object of the invention to find an illumination device and a method suitable for operating such an illumination device which make it possible to assign individual emission characteristics to the individual light sources.

The invention is achieved by means of a wideband illumination device and a method suitable for operating such an illumination device having the features of patent claims 1 and 14.

The invention relates to a wideband illumination device, in particular for use in a motor vehicle, which is formed by a multiplicity of semiconductor light sources. In this case, one portion of the semiconductor light sources emits light in the visible wavelength region and another portion of the semiconductor light sources emits light in the non-visible wavelength region. In a particularly inventive manner, at least some of the semiconductor light sources are now provided individually or in groups with optical arrangements for generating an individual emission characteristic. This makes it possible, in an advantageous manner, for light with a different emission characteristic to be emitted by different light sources which are preferably light emitting diodes or semiconductor lasers, within a single illumination device.

It is thus conceivable, by way of example, to produce a combined, close-range and high-beam headlight by means of the illumination device according to the invention by virtue of individual light sources which emit visible light being provided individually with different optical arrangements, so that the region in front of the motor vehicle is illuminated differently depending on activation of the light sources individually or in groups. It is therefore no longer necessary to use separate headlights, or two or bipartite incandescent bulbs (with differently arranged incandescent filaments) within a headlight, for the low- and high-beam range. Different illumination characteristics can thus be obtained with a single illumination module on which the semiconductor light sources provided with the optical arrangements are applied. For this purpose, it is only necessary to provide the illumination device with an electronic control unit that enables the individual semiconductor light sources to be driven individually or in groups individually. In a particularly advantageously manner, this driving furthermore makes it possible to influence the radiation intensity of the individual semiconductor light sources, so that the entire radiation characteristic of the inventive illumination device can be adapted to different illumination requirements, in particular with regard to the illumination range and also the illumination intensity.

The combination of semiconductor light sources which emit visible light with those which emit non-visible light makes it possible to provide a compact wideband illuminator that is robust with respect to vibrations. Such a wideband illumination device is outstandingly suitable for use in a motor vehicle since both the close range and the far range in front of the vehicle can be illuminated with visible light by means of a single headlight, but this can also be used as a light source in the context of a system for improving night visibility. What are suitable in this case are primarily semiconductor light sources which emit light in the infrared or ultraviolet wavelength region. It is now possible, in a beneficial manner in the configuration of the wideband illumination device, for the ratio of the semiconductor light sources which emit visible light to those which emit non-visible light to be chosen differently depending on the area of use. Since, by way of example, infrared semiconductor lasers are not visible to the human eye, they can operate with significantly higher radiation densities particularly in pulsed operation. It is conceivable, therefore, that the number of infrared light sources required in the illumination device according to the invention could be chosen to be significantly lower than the number of light sources which emit visible light and by means of which, by way of example, the high-beam range should be illuminated satisfactorily.

On the other hand, however, a use of the illumination device according to the invention as a special infrared headlight is also conceivable, in particular for use in the context of a motor vehicle system for improving night visibility. When using infrared headlights on the front side of a motor vehicle, however, it is necessary to take account of the legal provisions relating to traffic which state that no light source that emits visible red light is permitted to light up on the front of a vehicle. If the headlight emits light in the near infrared region, then there is the risk that this will still be perceived as a weak red shimmer by some persons. In order to avoid this, it is therefore possible, in an advantageous manner, for a smaller number of semiconductor light sources of the illumination device according to the invention to emit visible, in particular, white, light which serves to cover the red light shimmer. It may also be advantageous with regard to eye safety for a certain number of semiconductor light sources to emit visible light with an intensity such that no human observer looks directly at the headlight for a relatively long time.

In order, in the case of the wideband illumination device, to be able to emit light with sufficient intensity and radiation density both in the visible and in the non-visible wavelength region, flat optical arrangements, the light entry opening of which have an elongate, essentially rectangular form, are suitable in a particularly advantageous manner. Such flat optical arrangements especially require only a relatively small structural space, even when there are a large number of individual optical arrangements, and enable an optimum area density of light sources. Optical arrangements which have, perpendicular to the light entry area, a central region whose projection into a two-dimensional plane corresponds to a cylindrical two-dimensional Cartesian oval are especially suitable. Said central region is particularly advantageously combined with a parabolic reflector. Optical arrangements configured in this way are described, for example, in the German patent application DE 102 49 819 (asymmetrical headlight), after the priority date.

The structural space present when the semiconductor light sources are ordered alongside one another can be further optimized if a plurality of semiconductor light sources are assigned to at least some of the individual optical arrangements. Although the light emitted by individual semiconductor light sources assigned to a common optical arrangement in this way then has an individually different radiation characteristic, since each light source is arranged at a different location in relation to the focal point of the optical arrangement, different radiation characteristics generated in this way are nevertheless advantageous for many conceivable applications of the inventive illuminating device. It is thus generally desirable for the close-range headlights operating with visible light, for the purpose of preventing dazzle, principally to emit light in the region of the roadway lying ahead of it, while at the same time the non-visible light component of the headlight light, which serves for improving night visibility, also illuminates regions on the oncoming roadway or at the roadside.

If the individual semiconductor light sources are driven by electronics that permit the light sources to be operated individually or in groups and, in particular, also to be influenced with regard to their luminous intensity, it is also conceivable, in an advantageous manner, for the illumination device according to the invention also to be connected to a communication system or a system for a distance measurement as part of the transmitting device thereof. In interaction with a communication system, portions of the semiconductor light sources, in particular those which emit light in the non-visible wavelength region, can be modulated in terms of their beam intensity on the basis of a communication signal. Such a beneficial refinement of the wideband illumination device makes it possible to establish a vehicle-to-vehicle communication with the aid of the vehicle illumination.

It is likewise conceivable, in interaction with a system for distance measurement, by means of the illumination device according to the invention, to emit the measurement pulses through pulsed activation of at least one portion of the semiconductor light sources, which measurement pulses are then received, after reflection at objects, by the receiving device of the distance measuring system, said receiving device being synchronized with said measurement pulses. In this way, it is possible not only to determine the distance from the vehicles ahead, but also by way of example, to estimate the current visibility even in thick fog or rain. In this case, in the context of its use as a front headlight of a motor vehicle, the inventive illumination device can be utilized for example in the case of regulating the distance from vehicles ahead. Furthermore it is conceivable to use the illumination device as a luminaire on the rear side of the vehicle and additionally to utilize the latter, for example in combination with a regulated rear foglamp, for measuring the distance to following vehicles.

1. A wideband illumination device, in particular for use in a motor vehicle,
which is formed by a multiplicity of semiconductor light sources,
one portion of the semiconductor light sources emitting light in the visible wavelength region,
and another portion of the semiconductor light sources emitting light in the non-visible wavelength region, wherein
at least some of the semiconductor light sources are assigned individually or in groups to optical arrangements for generating an individual emission characteristic.

2. The wideband illumination device as claimed in claim 1, wherein
at least one portion of the semiconductor light sources are light emitting diodes or semiconductor lasers.

3. The wideband illumination device as claimed in claim 1, wherein
the semiconductor light sources which emit light in the non-visible wavelength region emit light in the infrared or ultraviolet wavelength region.

4. The wideband illumination device as claimed in claim 1, wherein
the plurality of semiconductor light sources emit light in the visible wavelength region.

5. The wideband illumination device as claimed in claim 1, wherein
the plurality of semiconductor light sources emit light in the non-visible wavelength region.

6. The wideband illumination device as claimed in claim 1, wherein
the light entry opening of the optical arrangements have an elongate, essentially rectangular form.

7. The wideband illumination device as claimed in claim 6, wherein
the optical arrangements have, perpendicular to the light entry area, a central region whose projection into a two-dimensional plane corresponds to a cylindrical two-dimensional Cartesian oval, and in that said central region is combined with a parabolic reflector.

8. The wideband illumination device as claimed in claim 1, wherein
the optical arrangements assigned to the semiconductor light sources have at least in part different emission characteristics.

9. The wideband illumination device as claimed in claim 1, wherein
a plurality of semiconductor light sources are assigned to individual optical arrangements.

10. The wideband illumination device as claimed in claim 8, wherein
the emission behavior of the illumination device for visible light differs from that for non-visible light.

11. The wideband illumination device as claimed in claim 1, wherein
means are provided in order to drive the semiconductor light sources individually or in groups individually.

12. The wideband illumination device as claimed in claim 11, wherein
means are provided in order to drive the semiconductor light sources individually or in groups with a different intensity.

13. The wideband illumination device as claimed in claim 11, wherein
the illumination device is connected to at least one of a communication system and a system for distance measurement.

14. A method for operating a wideband illumination device, comprising:
forming an array of individual optical arrangements that are in each case assigned at least one semiconductor light source, in particular a light emitting diode,
emitting light in the visible wavelength region by means of one portion of the semiconductor light sources, and
emitting light in the non-visible wavelength region with another portion of the semiconductor light sources, wherein
the semiconductor light sources can be driven individually or in groups individually.

15. The method for operating a wideband illumination device as claimed in claim 14, wherein
the semiconductor light sources can be driven individually or in groups with a different intensity.

16. The method for operating a wideband illumination device as claimed in claim 14, wherein
the light radiation of the semiconductor light sources, in particular of those which emit light in the non-visible wavelength region, can be pulsed or modulated with communication signals.

17. The method according to claim 14, wherein said method is for distance measurement and/or determining visibility range.

18. The method according to claim 14, wherein said method is used in a system for improving night visibility which operates on the basis of active infrared or ultraviolet ambient illumination.

19. The method according to claim 14, wherein said method provides as a vehicle-vehicle communication system in a motor vehicle.
